(19) United States
(12) Patent Application Publication
(10) Pub. No.: US 2005/0272868 A1
(43) Pub. Date: Dec. 8, 2005

(54) Free radical polymerisation process for microgel preparation

(76) Inventors: Greg Guanghua Qiao, Doncaster East (AU); David Henry Solomon, Murrumbeena (AU); Paul Andrew Gurr, Box Hill North (AU); Martin Frederick Mills, Ashfield (AU)

Correspondence Address: NORRIS, MCLAUGHLIN & MARCUS, 875 THIRD AVE, 18TH FLOOR, NEW YORK, NY, 10022, US

(21) Appl. No.: 11/138,144

(22) Filed: May 26, 2005

(30) Foreign Application Priority Data
Nov. 27, 2002 (AU) 2002953369

(51) Int. Cl. C08L 33/08

(52) U.S. Cl. 525/123

(57) ABSTRACT

This invention relates to a process for preparation of a microgel comprising polymerising a monomer composition comprising a monounsaturated monomer and a multiunsaturated crosslinking monomer as a solution in an organic solvent, by free radical solution polymerisation wherein the reactivity ratio of the monounsaturated monomer is significantly different from the multiunsaturated monomer and the concentration of the monomer component and the proportion of crosslinking monomer in said monomer composition is controlled to provide a solution of discrete microgel particles of number average molecular weight of at least 10⁵

### FIELD

The present invention relates to a process for the preparation of microgels and to a composition for use in such a process.

### BACKGROUND

Microgels are macromolecules which possess a combination of very high molecular weight and a solubility and viscosity similar to linear or branched polymers of relatively low molecular weight. Microgels are an intermediate structure between conventional linear or branched polymers such as polyethylene or polycarbonate and networks such as vulcanised natural rubber. The dimensions of microgels are compatible with high molecular weight linear polymers but their internal structure resembles a network.

The properties of microgels make them particularly useful in a wide range of applications such as in additives, in advanced material formulations for foams or fibres, in coating compositions, binders and redispersible latexes. Microgels may also be used to improve the ease of processing and to improve the structural strength and dimensional stability of the final products. A further potential use for microgels is as additives for high impact polymers. Microgels embedded in a matrix of conventional linear polymer may act to stabilise the whole structure by distributing mechanical tension. Microgels are also useful in biological systems and as pharmaceutical carriers.

A number of methods have been used for the preparation of microgels, however these methods generally have a number of serious deficiencies. For example, extreme care is required in preparing microgels as the multiple double bonds present within these systems may readily undergo intermolecular reactions which can lead to intractable networks. Other procedures such as those described by OKay, O. and Funke, W. in MACROMOLECULES, 1990, 23 at 2623-2628 require high purity solvent and reagents as well as an inert atmosphere and are complicated by undesirable side reactions. Despite the unique properties of microgels the difficulties in preparing them have limited their potential and commercial use.

Our copending application PCT/AU98/00015 discloses a process for microgel preparation involving reacting an alkoxy amine with a cross-linking agent in two steps.

The first step involves formation of a linear pre-polymer by using nitroxide mediated controlled polymerization methodology and the second step involves crosslinking of these pro-polymers on their one living ends using crosslinking agents such as a multy-olefin to form star-shaped microgels. The microgel formation step is also a controlled polymerization process as the incorporation of crosslinking agent going through the radicals formed from nitroxide-capped living prepolymer by dissociation of the nitroxide capping groups.

Our further copending International Applications, PCT/AU99/00345 and U.S. Pat. No. 6,355,718, expanded this work to a broad range of controlled polymerization methods. Again a two step procedure involve a first step of providing a living pre-polymer by a controlled polymerization methods and a second step polymerizing these living radicals together with a crosslinking monomer to form microgels.

Example of the living polymerization methods include ATRP, RAFT or other living free radical polymerization methods.

The microgels produced by the controlled polymerization will give defined star-shape structures. The length and the number of the arms, size and density of the cores can be controlled by the length of pre-polymers, polymerization formulations and other reaction conditions.

### SUMMARY

We have now found that microgels with similar rheology properties to star microgels obtained using controlled “living” prepolymers can be prepared directly by free radical polymerization of a monomer composition comprising a crosslinking monomer and a monounsaturated monomer provided monomer components are chosen which have a significant difference in reactivity and the concentration of components is controlled.

The invention provides a method for preparing a microgel composition comprising
(i) providing a monomer composition comprising a monounsaturated monomer and a multiunsaturated cross-linking monomer as a solution in an organic solvent, and
(ii) polymerizing the monomer by free radical solution polymerisation wherein the reactivity ratio of the monounsaturated monomer is significantly different from the multiunsaturated monomer and the concentration of the monomer component and the proportion of cross-linking mononer in said monomer composition is controlled whereby a solution of discrete microgel particles of weight average molecular weight of at least 50,000 is formed.

The proportion of multiunsaturated monomer is typically less than 20% by weight of the total monomer component and more preferably less than 15% of weight of the total monomer component.

Most preferably the crosslinking monomer is in the range of from 0.1 to 15% by weight of the total monomer.

The total monomer concentration is typically from 5 to 50% by weight, more preferably from 10 to 50%, still more preferably from 20 to 45% and most preferably 25 to 45% by weight.

The step of polymerizing the monomer composition by free radical solution polymerization will typically involved a free radical initiator.

Microgels formed in accordance with the process of the invention provide surprisingly unusual Theological properties. For a normal linear polymer, viscosity of a polymer solution is proportional to its molecular weight (MW). That means that with the increase of MW, the viscosity of the polymer will increase. However, we found, those star-shaped microgels behave very differently. The viscosity of a star microgel solution is not proportional to its molecular weight. When MW of the microgel increased from 300 K to 1.2 million, the intrinsic viscosity of the solution kept constant at about 0.2 g/dl. Such behaviour is unusual and can provide huge effect in the application of these materials in coating or drug delivery. High molecular weight polymer normally gives better mechanical properties for a coating; however, dilution is normally needed due to its high viscosity. With microgel described here, a low viscosity solution can be achieved at high solid content. Consequently, better coating can be made and less solvent is need for the coating process. In drug delivery, the low viscosity functionalized star microgel can provide a medium for adsorption of drug molecules and release them over time during their application.

### DETAILED DESCRIPTION

The invention allows the use of conventional free radical polymerization methods. In these methods, polymerization will be initiated by an initiator and the monomer composition contains at least one monomer with one double bond and at least one multi-unsaturated crosslinker. The keys to prepare such microgels are: a) the ratio between the monomer and crosslinker and the total concentration of the monomers and crosslinkers used; and b) a difference in reactivity of monomer and crosslinker.

Reactivity Ratio

The reactivity ratio (r) of two different monomers is defined as the reactivity of the radical from the first monomer reacting with the first monomer over the reactivity of the radical reacting with the second monomer:
Reactivity Ratio r₁=K₁₁/K₁₂

Similarly,
Reactivity Ratio r₂=K₂₂/K₂₁
Here K₁₁ is the reaction rate of the radical from the first monomer reacting with the first monomer and K₁₂ is the radical from the first monomer reacting with the second monomer.

The conventional approach used to form a crosslinked polymer composition is by choosing similar reactivity ratio r, and r₂. When r₁=r₂₌1, the crosslinker enters the polymer chain in a statistical manner depending on the concentration. This result in an infinite cross-linked network.

It is preferred that the cross-linker has a higher reactivity than the monounsaturated monomer. Preferably the reactivity ratio (r) of at least one cross-linker to at least one monomer (r1) is at best 1.5. More preferably the ratio is in the range of 1.5-30. On the other hand r₂ (the reactivity ratio of the mono-unsaturated monomer) is preferably to be less than 0.5; more preferably less than 0.1.

A particularly preferred example of crosslinking monomers having the required reactivity is ethylene glycol dimethacrylate (EGDMA). The most preferred monounsaturated monomers are acrylates such as isobornyl acrylate, methyl acrylate, butyl acrylate, ethyl hexyl acrylate and higher alkyl acrylates such as C₈ to C₂₀ alkyl acrylates (eg lauryl acrylate).

One (EGDMA) will have higher reactivity to incorporate into a polymer chain than methyl acrylate. Microgels prepared from MA/EGDMA showed much lower viscosity compared with microgel produced from MMA/EGDMA. Here the reactivity of double bond from both MMA and EGDMA are very similar. It was also found that when MMA reacted with ethylene glycol diacrylate (EGDA) under certain conditions, the resultant microgels also give low viscosity properties. Broadly, under specified conditions, when the reactivity of monomers and crosslinker are different, it is possible to produce microgels with special rheology properties that is similar to the one produced as star-microgel using controlled or semi-controlled polymerization methodologies.

The following table lists suitable crosslinkers and monomers with the reactivity values to allow the formation of star-like microgels.

TABLE 1

| Crosslinker | Monomer |
|---|---|
| EGDMA | MA |
| | Vinyl acetate |
| | Vinyl benzoate |
| | Vinyl phenyl acetate |
| | Acrylamide |
| EGDA | Methacrylamide |

In one embodiment of the invention the crosslinking agent component, the monounsaturated monomer component or both, comprise a monomer adapted crosslink with a polymeric binder for use in curing of a coating composition adhesive or elastomer.

In this embodiment the preferred functional groups are selected from hydroxyl, epoxy, carboxylic acid, amine, alkoxysilane and combinations thereof. Examples of functionalised monomers include:
(i) Acids: acrylic acid, methacrylic acid
(ii) Epoxy: glycidyl methacrylate
(iii) Hydroxy: Hydroxy ethyl acrylate, hydroxypropyl acrylate and methacrylate analogues;
(iv) Amino: Dimethyl amino ethyl methacrylate; and
(v) Siloxane: gamma methacryloxy propyl trimethoxy silane and partially or fully higher alkyl substituted analogues.

A functionalised monounsaturated monomer is preferred and hydroxy functionalised monounsaturated monomer is particularly preferred. In this embodiment it is not necessary for the whole monounsaturated monomer component to be functionalised, it may be sufficient in most cases to use a minor proportion of for example from 0.1 to 30 mole % of the relevant composition of functionalised monomer and more preferably from 0.1 to 10 mole %.

While the preferred process is to use an acrylate as the monofunctional momoner, many of the commonly used functionalised monomers may be methacrylates. However as these are generally a minor proportion of the total monomer used (Probably less than 10% of total monofunctional monomer), they may still be incorporated without too much adverse affect.

The most preferred functionalised monounsaturated monomer is a hydroxylalkyl acrylate or hydroxyalkylmethacrylate such as hydroxyethylacrylate or hydroxyethylmethacrylate. Suitable amino and alkylaminoalkyl acrylates or methacrylates may also be used.

Concentration of Monomer and Cross-Linker

The optimum combination of total monomer concentration (herein referred to as “T %”) and proportion of crosslinking monomer in the monomer composition (herein referred to as “C %”) can be chosen for a particular system without undue experimentation.

For a given proportion of cross-linker less than 20% by weight the optimum total monomer concentration can be determined by selecting the concentration to form products of molecular weight of at least 10⁵ without gellation. Gellation will occur where either the total monomer concentration or proportion of cross-links is too high. If the total monomer concentration is too low or the proportion of cross-links is too low the resulting product of free radical polymerization will be polymers of relatively low molecular weight.

The polymerization is conducted in a homogeneous solution of an organic solvent. A range of solvents may be used. Suitable solvents may be selected having regard to the nature of the monomers and the need to allow efficient radical polymerization.

Microgels formed in accordance with the process of the invention provide surprisingly unusual Theological properties. For a normal linear polymer, viscosity of a polymer solution is proportional to its molecular weight (MW). That means that with the increase of MW, the viscosity of the polymer will increase. However, we found, those star-shaped microgels behave very differently. The viscosity of a star microgel solution is not proportional to its molecular weight. When MW of the microgel increased from 300 K to 1.2 million, the intrinsic viscosity of the solution kept constant at about 0.2 g/dl. Such behaviour is unusual and can provide huge effect in the application of these materials in coating or drug delivery. High molecular weight polymer normally gives better mechanical properties for a coating; however, dilution is normally needed due to its high viscosity. With microgel described here, a low viscosity solution can be achieved at high solid content. Consequently, better coating can be made and less solvent is need for the coating process. In drug delivery, the low viscosity functionalized star microgel can provide a medium for adsorption of drug molecules and release them over time during their application.

The microgels may be isolated from the reaction solvent by adding the microgel solutions (preferably dropwise) to a large volume of polar solvent, particularly methanol to induce precipitation. They may then be collected from solution by filtration, using a centrifuge or other suitable techniques for collecting a precipitate.

While the controlled polymerization methods of our prior inventions are efficient and provide high quality microgels the method of this invention allows formation of microgels in a one-pot procedure using low molecular weight components. Further the ability to use conventional polymerization initiators provides even more efficient preparation and avoids the radical capping agents or lewis acids that may reduce stability of the product or require removal.

Throughout the description and claims of this specification, the word “comprise” and variations of the word such as “comprising” and “comprises”, is not intended to exclude other additives or components or integers.

The invention will now be described with reference to the following examples. It is to be understood that the examples are provided by way of illustration of the invention and that they are in no way limiting to the scope of the invention.

### EXAMPLES

The inventions are described in part with reference to the attached drawings.

In the drawings:

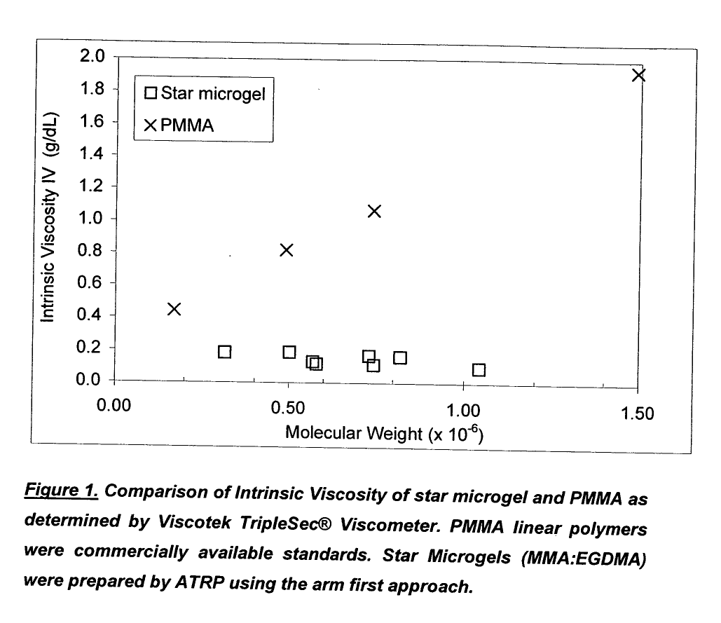

FIG. 1 compares the charge in intrinsic viscosity with molecular weight for a microgel of the invention with PMMA;

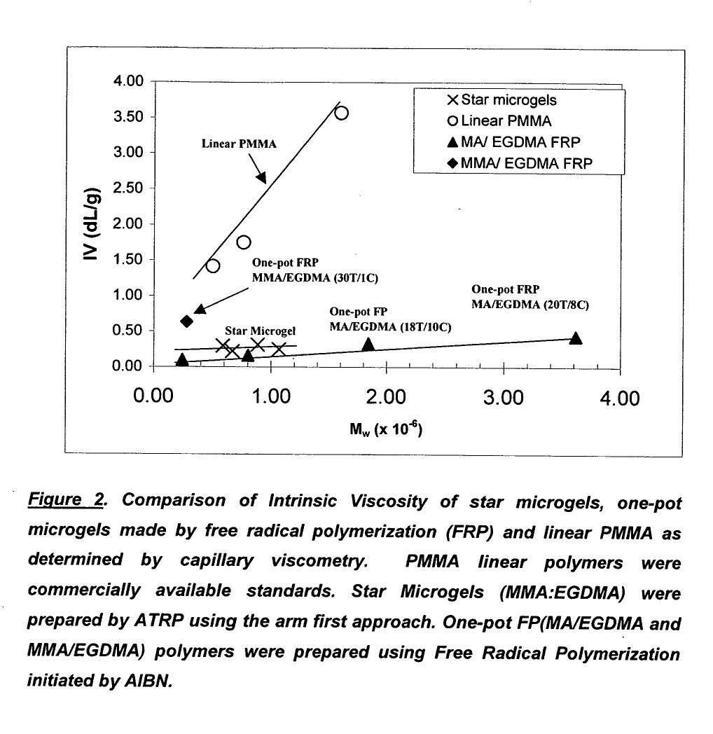

FIG. 2 is a graph comparing intrinsic viscosity of a star microgel, one-pot microgels made by free radical polymerization (FRP) and linear PMMA as determined by capillary viscometry;

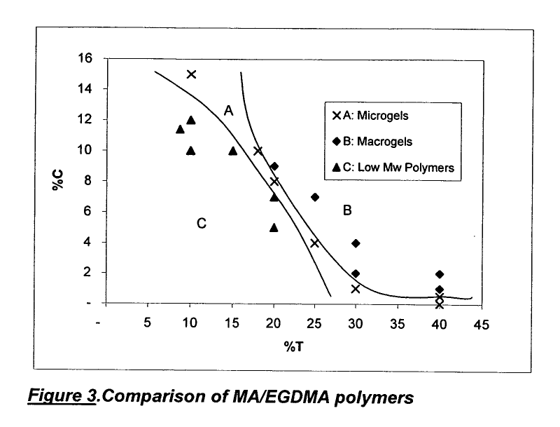

FIG. 3 is a graph showing the formulation regime required for microgel formation;

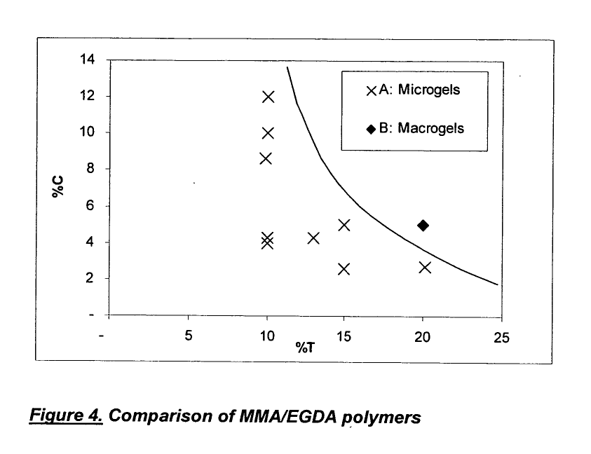

FIG. 4 is a graph showing the comparison of MMA/EGDA polymers;

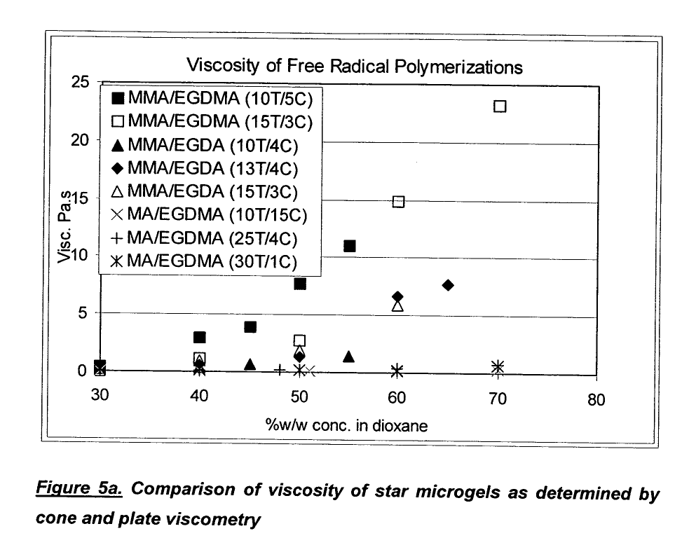

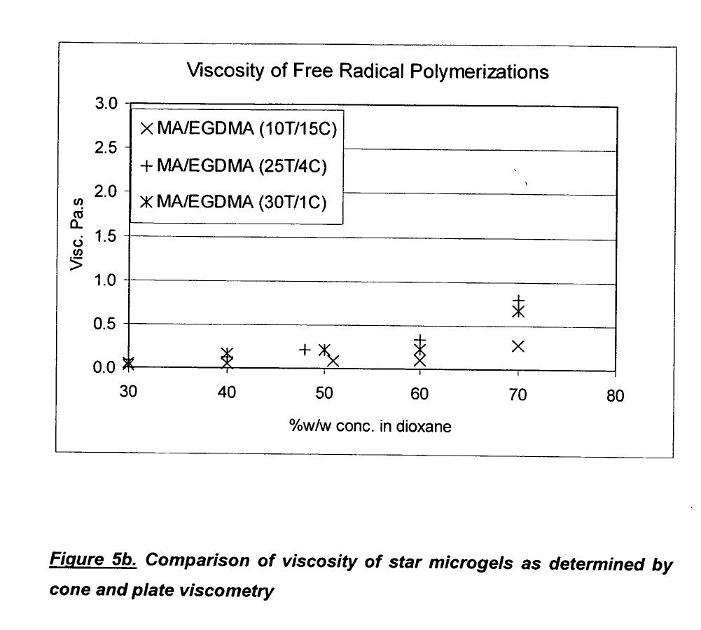

FIG. 5a is a graph showing the comparison of viscosity of star microgels as determined by cone and plate viscometry;

FIG. 5b is a graph showing the comparison of star microgels as determined by cone and plate viscometry; and

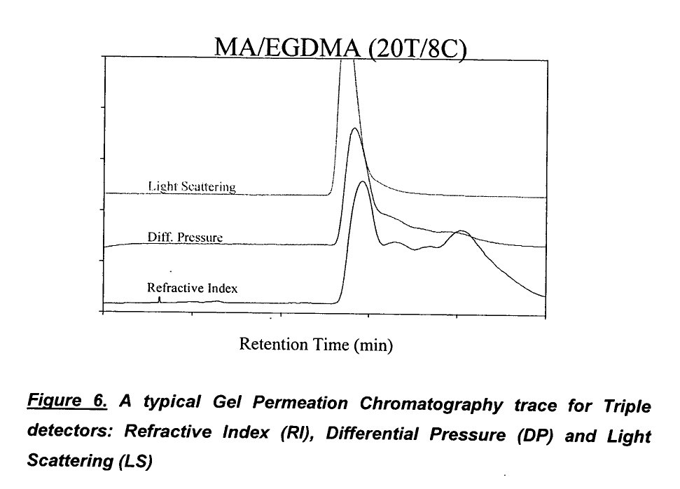

FIG. 6 is a graph of a typical gel permeation chromatography trace for Triple detectors: showing the Refractive Index (RI), the Differential Pressure (DP) and Light Scattering (LS).

### Example 1

a) Synthesis of PMMA Macroinitiator ‘Arms’ (PMMA)

A mixture of methyl methacrylate (12.8 mL, 0.12 mol), CuBr (0.17 g, 1.2 mmol), PMDETA (0.25 mL, 1.20 mmol) and p-toluene sulphonyl chloride (p-TsCl, 0.51 g, 2.7 mmol) in p-xylene (17.2 mL) was added to a Schlenk flask and degassed by three freeze-pump-thaw cycles. The flask was then immersed in an oil bath at 80 and heated for 90 h. The reaction mixture was dissolved in THF (100 mL) and precipitated into MeOH (2 L). The precipitate was collected by vacuum filtration and the precipitation repeated to afford PMMA macroinitiator (1) as a white solid (55% yield, Mw 10.0 k). ¹H NMR (CDCl₃, 400 MHz): 7.74 (d, J=8.2 Hz, 0.03H, ArH), 7.36 (d, J=8.0 Hz, 0.03H, ArH), 3.60 (s, 3H, OCH₃), 2.0-1.7 (m, 2H, CH₂), 1.02 (s, 0.45H, CH₃) 0.83 (s, 0.55H, CH₃).

b) Synthesis of PMMA/MMA/EGDMA Star Microgel

A mixture of (1) (0.62 g, 0.062 mmol), EGDMA (0.18 mL, 0.93 mmol), MMA (0.40 mL, 3.7 mmol), CuCl (6.2 mg, 0.062 mmol) and bpy (29 mg, 0.19 mmol) in p-xylene (12.2 mL) was added to a Schlenk flask equipped with a magnetic stirrer. The mixture was degassed by three freeze-pump-thaw cycles and then heated at 100° at atmospheric pressure. After 90 h a sample was taken from the reaction mixture and analyzed directly by GC. The mixture was diluted with THF (20 mL), precipitated into MeOH (1 L) and collected by filtration to afford a colourless solid, which was analyzed by Gel Permeation Chromatography (GPC) (0.98 g, 83% yield, Mw=569,400).

### Example 2

Intrinsic Viscosity by Viscotek TriSec® Viscometer

Samples were prepared at 10-20 mg/mL in THF. Size exclusion chromatography (SEC) measurements in THF were carried out using a Waters 717 Plus Autosampler, a Waters 510 HLPC pump equipped with three Phenomenex phenogel columns (500, 10⁴ and 10⁶ Å) in series with a Wyatt Dawn F laser photometer operating at 90° then in parallel with a Waters 410 differential refractometer (RI) and a Viscotek T50A differential viscometer. Data acquisition and analysis were performed with Viscotek TriSEC® software.

Compared to linear polymethyl methacrylate, star microgels were determined to have much lower intrinsic viscosities for polymers of similar molecular weight (FIG. 1).

### Example 3

Viscosity test by Capillary Viscometry

The intrinsic viscosity of star microgel, one-pot microgels and linear polymer arm prepared in example 1, 4 and 5, were determined by Ubelhode capillary viscometry. Samples of varying concentrations were prepared in THF and the efflux time measured for each. From the following equations determination of inherent and reduced viscosities versus sample concentration was plotted.
Relative viscosity: ηᵣₑₗ=t/t₀
Specific viscosity: ηₛₚ=[t−t₀]/t₀
Reduced viscosity: η_{red}=ηₛₚ/c
Inherent viscosity: ηᵢₙₕ=1nηᵣₑ/c

$$Intrinsic viscosity \text{:} [ η ] = lim \frac{{η}_{red}}{c} = lim \frac{ln ( η / {η}_{0} )}{c}$$

The intrinsic viscosity is determined by extrapolating both the Huggins (reduced viscosity v conc.) and the Kraemer (inherent viscosity v conc.) plots to the y-axis (c=0). A plot of the determined intrinsic viscosities by capillary viscometry for linear polymethyl methacrylate, one-pot microgels and star microgels are shown in FIG. 2.

### Example 4

MMA and EGDMA One-Pot Free Radical Polymerization (15% T, 3% C)

A mixture of methyl methacrylate (2.8 g), ethylene glycol dimethacrylate (0.09 g) and 2,2′-azobisisobutyronitrile (AIBN, 0.02 g) in p-xylene (16.2 ml) was added to a Schlenk flask equipped with a magnetic stirrer. The mixture was degassed by three freeze-pump-thaw cycles and then heated at 100 degrees for 90 h. A sample of the mixture was diluted (1:10) in p-xylene and analyzed by Gas Chromatography to determine the conversion of monomers (MMA conversion 92%; EGDMA conversion 88%). A second sample was analyzed by SEC (for MW and viscosity parameters) and the remainder was precipitated into methanol to afford a white solid after filtration (Mₙ64K; M_{w}201K; IV_{w} 0.20 dL/g; Rg_{w} 10.3 nm).

### Example 5

MA and EGDMA One Pot Free Radical Polymerization (20% T, 8% C)

A mixture of methyl acrylate (4.8 g), ethylene glycol dimethacrylate (0.42 g) and 2,2′-azobisisobutyronitrile (AIBN, 0.09 g) in p-xylene (21 ml) was added to a Schlenk flask equipped with a magnetic stirrer. The mixture was degassed by three freeze-pump-thaw cycles and then heated at 100 degrees for 90 h. A sample of the mixture was diluted (1:10) in xylene and analyzed by Gas Chromatography (MA conversion 91%; EGDMA conversion 90%). A second sample was analyzed by SEC and the remainder was isolated by removal of the solvent in vacuo (Mₙ 26K; M_{w} 3,615K; IV_{w} 0.49; Rg_{w} 31 nm).

### Example 6

MMA and EGDA One Pot Free Radical Polymerization (15% T, 3% C)

A mixture of methyl methacrylate (2.8 g), ethylene glycol diacrylate (0.08 g) and 2,2′-azobisisobutyronitrile (AIBN, 0.05 g) in p-xylene (16.2 ml) was added to a Schlenk flask equipped with a magnetic stirrer. The mixture was degassed by three freeze-pump-thaw cycles and then heated at 100 degrees for 90 h. A sample of the mixture was diluted (1:10) in xylene and analyzed by Gas Chromatography (MMA conversion 90%; EGDA conversion 89%). A second sample was analyzed by SEC and the remainder was isolated by removal of the solvent in vacuo (Mₙ 30K; M_{w} 59K; IV_{w} 0.14 dL/g; R_{g} 6.2 nm).

### Example 3A

Formulations for Preparing MA/EGDMA Microgels

One-pot free radical polymerizations with monomers MA/EGDMA in various formulations according to method described in (Mₙ 64K; M_{w} 201 K; IV_{w} 0.20 dL/g; Rg_{w} 10.3 nm).

Example were prepared. The resultant polymers were tested and were found to fall into 3 possible domains: A: microgels, B: macrogels and C: low MW polymers.

FIG. 3 shows the formulation regime (% T vs % C) where region A is required for microgel formation.

### Example 4A

Formulations for preparing MMA/EGDA microgels

One-pot free radical polymerizations with monomers MMA/EGDA in various formulations according to method described in Example were prepared. The resultant polymers were tested and were found to fall into 3 possible domains: A: microgels, B: macrogels and C: low MW polymers. FIG. 4 shows the formulation regime (% T vs % C) where region A is required for microgel formation.

### Example 5

A Carrimed Rheometer CSL100 with cone and plate geometry (2 cm cone, 2 degree angle, gap between plates=54 um, 25° C., air pressure of 2.5 bar) was used to analyze the viscosities of microgels from examples 4-6. Samples of varying concentration in dioxane (from 30 to 70% w/w) were prepared and left to dissolve overnight. Measurements were obtained using shear stress sweep method, which allows the modification of the end stress. The measured viscosity data plotted against shear rate to determine the viscosity profiles.

FIG. 5a-b shows the viscosity (Pa·s) for these samples as a function of concentration (w/w %).

### Example 6

Table 2 listed the molecular properties of microgels measured by SEC from samples prepared from Example 5 and 6.

TABLE 2
Experimental data for one-pot free radical polymerizations.

| | | Monomer/ | | |
|---|---|---|---|---|
| Number | Conc. | Crosslinker | Mn/10⁶ | Mw/10⁶ |
| IN1-30 | 9.9T/8.6C | MMA/EGDA | 49,610 | 282,200 |
| IN1-11 | 10T/10C | MMA/EGDA | 25,900 | 131,500 |
| IN1-35 | 10T/4.3C | MMA/EGDA | 42,240 | 87,520 |
| IN1-36 | 13T/4.3C | MMA/EGDA | 44,820 | 161,100 |
| IN1-29 | 20T/2.7C | MMA/EGDA | 25,130 | 181,200 |
| IN1-38 | 10T/15C | MA/EGDMA | 10,960 | 244,000 |
| IN1-39 | 18T/10C | MA/EGDMA | 38,250 | 1,844,000 |
| IN1-37 | 20T/8C | MA/EGDMA | 25,850 | 3,615,000 |
| IN1-47 | 25T/4C | MA/EGDMA | 7,245 | 802,800 |
| IN1-48 | 40T/0.5 | MA/EGDMA | 313 | 153,000 |

### Example 7

FIG. 6 shows GPC traces measured from samples prepared from MA/EGDMA in a formulation of 20 T % and 5C % by one-pot free radical polymerization.

### Example 8

One-Pot Free Radical Polymerization Using MA/EGDMA/HEA (20T/8C/2 H)

A mixture of methyl acrylate (3.08 mL, 2.94 g, 34 mmol), 2-hydroxyethyl acrylate (0.059 mL, 0.060 g, 51 mmol), ethylene glycol dimethacrylate (0.25 mL, 0.26 g, 1.3 mmol) and 2,2′-azobisisobutyronitrile (0.057 g, 35 mmol) in p-xylene (12.9 mL) were added to a Schlenk flask equipped with a magnetic stirrer. The mixture was degassed by three freeze-pump-thaw cycles under reduced pressure, sealed and heated at 90° C. for 18 h. The reaction mixture was reduced to dryness and a sample dissolved in THF and analyzed by GPC. Mn 8.1 K; M_{w} 273.9K; IV_{w} 0.205; Rg_{w} 9.83; Cone-and-plate viscosity @ 50% solids on dioxane (0.14 Pa·s).

1. A process for preparation of a microgel comprising polymerising a monomer composition comprising a monounsaturated monomer and a multiunsaturated crosslinking monomer as a solution in an organic solvent, by free radical solution polymerisation wherein the reactivity ratio of the monounsaturated monomer is significantly different from the multiunsaturated monomer and the concentration of the monomer component and the proportion of crosslinking monomer in said monomer composition is controlled to provide a solution of discrete microgel particles of number average molecular weight of at least 10⁵.

2. A process according to claim 1 wherein the proportion of multi-unsaturated monomer is less than 15% by weight of the total monomer component.

3. A process according to claim 1 wherein the total monomer concentration is from 10 to 50% by weight of the total composition.

4. A process according to claim 1 wherein the total monomer used in preparing the microgel comprises from 25 to 45% by weight of the total composition.

5. A process according to claim 1 wherein the reactivity ratio (r) of at least one crosslinker to at least one monomer is at least 1.5.

6. A process according to claim 1 wherein the reactivity ratio of the mono-unsaturated monomer is less than 0.5.

7. A process according to claim 1 wherein MW of the microgel increased from 300K to 1.2 million the intrinsic viscosity of the solution constant at about 0.2 g/dl.

8. A process according to claim 1 wherein the proportion of crosslinker is less than 20% by weight the total monomer and the total monomer concentration in the solution provides a molecular weight of at least 10⁵ without gellation.

9. A process according to claim 1 wherein the crosslinking monomer comprises ethylene glycol dimethacrylate and the monounsaturated monomer is selected from the group consisting of methyl acrylate, vinyl acetate, vinyl benzoate, vinyl phenyl acetate, acrylamide and mixtures of two or more thereof.

10. A process according to claim 1 wherein the monomer component comprises a monomer comprising at least one functional group selected from hydroxyl epoxy, carboxylic acid, amine, alkoxysilane and combinations thereof.

11. A process according to claim 10 wherein the monounsaturated monomer component comprises said monomer comprising at least one function group.

12. A process according to claim 11 wherein the crosslinking monomer comprises ethylene glycol dimethacrylate and the monounsaturated monomer comprises a hydroxy substituted alkyl acrylate or a hydroxy substituted alkyl methacrylate or mixture thereof.

13. A process according to claim 12 wherein the monounsaturated monomer is selected from the group consisting of hydroxyethylacrylate, hydroxyethylmethacrylate and mixtures thereof.

14. A process according to claim 9 wherein the monounsaturated monomer is methyl acrylate.
